(19) United States
(12) Patent Application Publication
(10) Pub. No.: US 2014/0233245 A1
(43) Pub. Date: Aug. 21, 2014

(54) LED-Based Lighting With Reflector Mounted On PCB

(71) Applicant: Hella KGaA Hueck & Co., Lippstadt, DE (US)

(72) Inventor: Alexander Kerpe, Lippstadt (DE)

(21) Appl. No.: 14/263,273

(22) Filed: Apr. 28, 2014

Related U.S. Application Data
(63) Continuation-in-part of application No. PCT/EP2012/071230, filed on Oct. 26, 2012.

(30) Foreign Application Priority Data
Oct. 28, 2011 (EP) 11187044.0

(51) Int. Cl. F21V 7/10; F21V 7/22

(52) U.S. Cl. CPC F21V 7/10; F21V 7/22
USPC 362/341; 362/296.01; 362/296.04; 362/296.02; 29/832

(57) ABSTRACT

An LED-based lighting component is disclosed. It comprises of a plurality of LEDs mounted to a printed circuit board. Furthermore, a surface mount reflector of a metal sheet with punched out reflector surfaces is located on the printed circuit board. The surface mount reflector forms at least two reflectors at opposing sides of each LED, reflecting and/or shading light from the LED. The surface mount reflector and the printed circuit board are held together within a frame.

### PRIORITY CLAIM

This application is a continuation-in-part of pending International Application No. PCT/EP2012/071230 filed on 26 Oct. 2012, which designates the United States and claims priority from European Application No. 11187044.0 filed on Oct. 28, 2011. The contents of both of these applications are incorporated by reference in their entireties.

### BACKGROUND OF THE INVENTION

1. Field of the Invention

The invention relates to a LED-based lighting component and to an assembly method of such a component. It specifically relates to a reflector for mounting to a printed circuit board holding LEDs.

2. Description of Relevant Art

LED lighting systems offer significant advantages over traditional incandescent, HID and fluorescent lamps. LEDs are of smaller size, offer higher reliability, longer operational life and lower energy consumption. However, there are specific requirements when using LEDs. As increased operating temperature significantly reduces lifetime, cooling is of high importance. Furthermore, most LED chips are approximately isotropic light sources with a lambertian light distribution, which must be adapted to specific requirements of a lighting system.

The US patent application publication 2008/027894181 A1 discloses a printed circuit board with LEDs soldered thereon. For adapting the light distribution, injection molded reflectors are positioned above each individual LED. The disadvantage is that the reflectors must be manually assembled to the printed circuit board. This is a complex and time-consuming step. Furthermore, the reflectors are comparatively complex and expensive. Because assembly is a different manufacturing step, the requirements of the assembly process with respect to tolerances and the risk of mechanical damages is very high.

EP 2 317 213 discloses a LED-module with a support, supporting optical elements and printed circuit boards each with at least one LED. Alternatively the optical elements may be integrally formed with the support. For mounting the optical elements to the support it is suggested to provide the optical elements with positioning pins being inserted in complementary recesses of the support, to position an optical element directly on the support or to integrate an optical element into the support.

U.S. Pat. No. 5,226,723 discloses a LED-display. The LED-display comprises a printed circuit board to which LED-chips are mounted. Subsequently a reflector is put in place. The reflector is a flush mount a layer formed on the printed circuit board. The reflector has bowl shaped reflective openings, each with a reflective surface surrounding a single LED-chip

US 2005/0237760 discloses a vehicular LED lamp. Each LED of the lamp is mounted to a flexible wiring body. A reflector is attached to a back cover of the LED lamp.

WO 2011/109097 suggest to provide a LED by bonding a semiconductor chip to a carrier. A reflector may be mounted to the same carrier.

### SUMMARY OF THE INVENTION

The problem to be solved by the invention is to provide means for cooling and adapting the light distribution of LEDs mounted to a carrier like a printed circuit board. Furthermore, the solution should be inexpensive and suitable for manufacturing in large volumes.

A preferred embodiment relates to a LED-based lighting component comprising a printed circuit board and at least one LED, preferably a plurality of LEDs mounted thereon. Preferably, a reflector is placed on the printed circuit board. Preferably, the reflector is a surface mount component. This means it is a component to which the surface mount technology is applicable, which may be mounted on soldering pads at the printed circuit board or glued to the surface of the printed circuit board. Usually surface mount components do not require holes or are otherwise penetrating the printed circuit board. Anyway, there may be specific embodiments of the surface mounted reflector which have posts to be held within holes of the printed circuit board. Preferably, the surface mount reflector is of sheet metal with reflector surfaces formed thereof. It may also comprise any ceramic or plastic materials, which withstand the soldering process. Preferably, these materials have at least one metallized or at least light reflecting surface. The reflector surfaces extend over the surface of the printed circuit board. They guide the light of the LED's LED-chip(s), which often have an approximated lambertian light distribution. The surface mount reflector can easily be manufactured from sheet metal by a simple process of punching and bending the reflector surfaces of the main plane, which is defined by the metal sheet. This allows for a precise and inexpensive manufacturing process of high volumes of the surface mount reflector.

The at least one LED is preferably as well soldered to the printed circuit board and may preferably as well be a so called “surface mount device” with soldering pads for soldering the LED to the same printed circuit board as the reflector. Placing the LED and the corresponding reflector on the printed circuit board can thus be executed in the same process, thereby reducing not only costs but as well tolerances of the relative position of the LED to its corresponding reflector. Thus, the light distribution of the LED-based lighting component is enhanced. Placing the LED and the reflector is preferably done by a single pick and place line, i.e. the same pick and place line. Even more preferably, the LED and the respective corresponding reflector are placed in a single, i.e. the same pick and place station of the pick and place line. A pick and place line may comprise one or more pick and place stations as well referred to as pick and place machines. Subsequent to placing the LED and the reflector they may be soldered in a common process to the printed circuit board. Placing includes positioning and fixing the LED or the reflector respectively on the printed circuit board. Fixing can be obtained by applying an adhesive to at least one the printed circuit board and the LED or the reflector, respectively.

Additional components like at least one sensor, transistor, resistor or capacitor may be placed as well on the printed circuit board and soldered to it.

In the context of this application it is distinguished between a “LED” and a “LED-chip”. A “LED” is a ready to mount electronic component with soldering pins or soldering pads for soldering the LED to a printed circuit board of a LED-light. However, a LED-chip as well known as “LED-die” is a piece of semiconductor material that requires some sort of protection, e.g. a housing, and bonding to soldering pins or pads to thereby provide a “LED”. So to speak at least one LED-chip is the semiconductor part of a LED. The LED-chip cannot be directly soldered to a printed circuit board, because its semiconductor structure would be affected or destroyed by the soldering process. The LED-chips are contacted by bond wires being bonded to the LED-chip.

Typically other electronic components, like at least one sensor, e.g. a temperature sensor, at least one of transistor, resistor of capacitor may be mounted to the printed circuit board as well. Additional LEDs e.g. of the same type may be mounted to the printed circuit board as well.

It is further preferred, if a surface mount reflector has at least one mounting pad. Most preferably, the surface mount reflector has at least two, three or four mounting pads. The surface mount reflector may be mounted to the printed circuit board by gluing or soldering preferably of the at least one mounting pad to the printed circuit board. Most preferably the surface mount reflector is placed to the printed circuit board by a SMD pick and place machine. Preferably, this is done in the same process as placing the LEDs and other electronic components to the printed circuit board, thus reducing tolerances and assembly time.

Furthermore, the printed circuit board may be inserted into a frame. For this purpose, the frame may have one or two braces. The frame may also serve as mechanical support, a heat sink or as an insulator of the assembly. The frame may be a strand casted, pultruded or extruded profile. It preferably has over-hangs to hold the surface mount reflector down to the printed circuit board and further to fix the reflector and the printed circuit board within the frame. To improve the fixation within the frame, the reflector may have springs. These assert a predetermined force to the reflector and therefore to the printed circuit board. This may further press the printed circuit board to the frame, further improving heat transfer to the frame. For easy assembly the printed circuit board is pushed into an opening at the end of the profile. Slipping of the printed circuit board within the profile my may be prevented by end caps or by a lug or a screw.

According to a further preferred embodiment, a surface mount reflector comprises at least one reflector surface. The surface mount reflector is preferably made of metal, which may be aluminum or brass, or any other material, which has a light reflecting surface. Most preferably the surface mount reflector is a metal sheet and the at least one reflector surface is punched from this metal sheet. The at least one reflector surface may be part of the surface of the metal sheet which is bent into an angle from a main plane of the metal sheet. Preferably, the surface mount reflector has at least one mounting pad for mounting the surface mount reflector to a printed circuit board. It is most preferred to have at least two, three or four mounting pads to allow stable positioning of the surface mount reflector on the printed circuit board.

In a further embodiment, the surface mount reflector has at least one blanking or opening for the at least one LED, thus surrounding the LED on the printed circuit board. The surface mount reflector may have further blankings leaving space for further electronic components on the printed circuit board.

In a preferred embodiment, the printed circuit board has a first surface mount reflector and a second surface mount reflector, being located at opposing sides of a LED. In another embodiment, the printed circuit board has four surface mount reflectors being located at or four sides of a rectangular LED. There may be any other number or any other shape of the surface mount reflectors.

Although it is preferred, that the surface mount reflectors reflect light from the LED into a different direction than it was emitted from the LED, the surface mount reflector may also and/or alternatively shade light from the LED, thus preventing light radiating into unwanted directions.

A further advantage is that the surface mount reflector may act as a heat sink for dissipating heat from the LED. For this purpose it is preferred if the surface mount reflector comprises of a heat conductive material. It is further preferred, if the surface mount reflector is mounted close to the LED and preferably contacts at least the same metallized layer as the thermal interface of the LED to improve heat transfer.

In a further embodiment, the surface mount reflector may be mounted at the opposite side of the LEDs of the printed circuit board. In this case, the printed circuit board may have at least one opening or slot, through which the individual surface mount reflector surfaces can penetrate the printed circuit board.

In a further embodiment, a frame may be provided. The frame may act as at least one of a mechanical support, a heat sink, an insulator. The frame may interact with springs on the surface mount reflectors for pressing the printed circuit board to the frame and therefore improving heat transfer. Preferably, the frame is a profile, which may be manufactured by strand casting or pultrusion or extrusion. The frame is preferably made of metal or ceramics, most preferably of aluminum.

Mounting the printed circuit board within the frame is a very simple procedure. The first step the surface mount reflector is positioned on or preferably fixed to the printed circuit board. In the next step, the printed circuit board is inserted into the frame by pushing them into a slot opening at one end of the frame. The frame may further support alignment of the surface mount reflector and the printed circuit board.

By means of a flat spring of the at least one surface mount reflector, the printed circuit board is held in a predetermined position relative to the frame.

This embodiment results in a defined pressure of the printed circuit board (PCB) to the frame without any additional elements (e.g. screws, glue, . . . ). Due to the permanent elastic deformation of the flat spring, the thermal resistance between the PCB and the frame will not change over lifetime.

Another aspect of the invention relates to a surface mount reflector as disclosed above.

A method according to the invention comprises at least the steps of placing at least one LED on a printed circuit board and placing at least a surface mount reflector to the same printed circuit board in the proximity of the at least one LED. The sequence of these steps can be reversed. Both steps are preferably done within the same manufacturing process. It is preferred, if both steps are done by pick and place machines. Therefore, no manual handling of the components is necessary. Consequently, a very high precision of placement and very low mechanical tolerances specifically of the relative positions of the at least one LED and the at least one surface mount reflector can be achieved. This results in low tolerances of the optical system and a very precise radiation pattern. Furthermore automatic handling prevents damaging or at least maladjustment of the at least one surface mount reflector. Most preferably, precision can be further increased by doing both steps with the same pick and place machine. After placing the at least one LED and the at least one surface mount reflector to the printed circuit board, it may be heated by a reflow oven and/or a solder wave to solder the at least one LED and the at least one surface mount reflector to the printed circuit board. These are examples of soldering the LED and the reflector in the same process step.

### BRIEF DESCRIPTION OF THE DRAWINGS

In the following, the invention will be described by way of example, without limitation of the general inventive concept, on examples of embodiment and with reference to the drawings.

FIG. 1 shows a preferred embodiment of the invention.

FIG. 2 shows the preferred embodiment in a side view.

FIG. 3 shows the preferred embodiment in a sectional view.

FIG. 4 shows the preferred embodiment assembled into a frame.

FIG. 5 shows a second embodiment of the invention.

FIG. 6 shows the second embodiment in a side view.

FIG. 7 shows another embodiment, with four reflector surfaces.

FIG. 8 shows a basic arrangement of a surface mounted reflector.

FIG. 9 shows a circular surface mount reflector.

FIGS. 10 to 13 show different embodiments of surface mounted reflectors.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

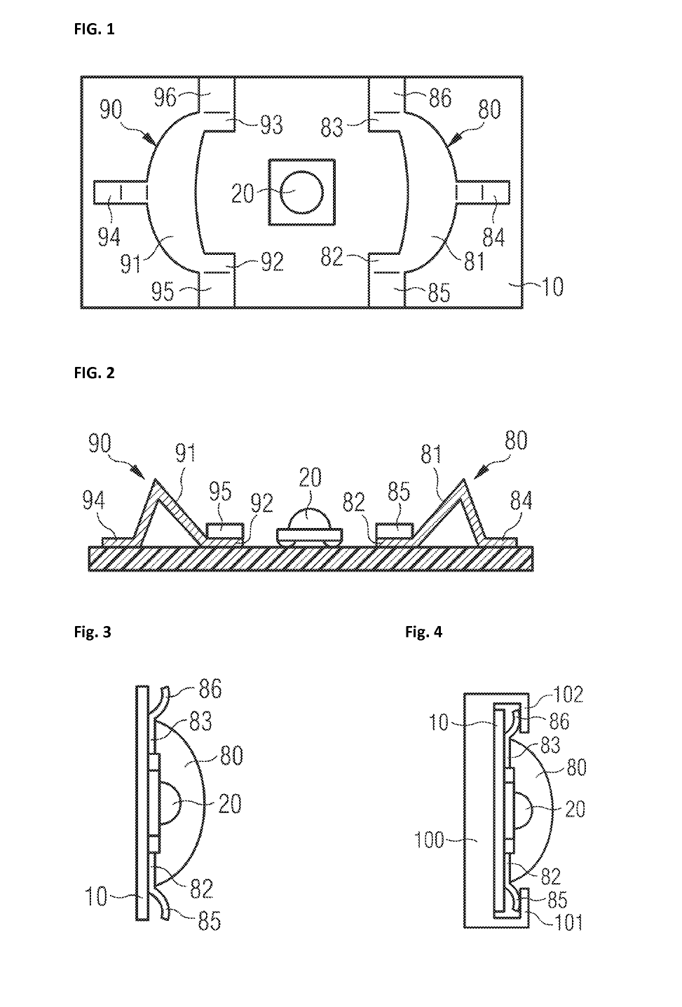

In FIG. 1, a preferred embodiment according to the invention is shown. A LED 20 is mounted to a printed circuit board 10. Furthermore, two surface mount reflectors 80, 90 are located on the printed circuit board, preferably opposing each other. These surface mount reflectors each have at least one reflecting surface 81, 91. Preferably, the surface mount reflectors 80, 90 have at least one, preferably three or four mounting pads 82, 83, 84, 92, 93, 94 for mounting and fixing the surface mount reflectors to the surface of the printed circuit board. These mounting pads may be glued and/or soldered to the printed circuit board. The surface mount reflectors may be placed at the printed circuit board by a pick and place machine. Furthermore there may be flat springs 85, 86, 95, 96. In general, there may be any number of LEDs and of surface mount reflectors on the printed circuit board.

FIG. 2 shows the preferred embodiment in a side view. Here the surface mount reflectors 80, 90 are shown from their sides standing with the mounting pads 82, 84, 92, 94 on the printed circuit board 10.

In FIG. 3, a sectional view is shown. It specifically shows the flat Springs 85 and 86 extending from mounting pads 82 and 83.

In FIG. 4, an embodiment with assembled printed circuit board and frame is shown. The printed circuit board 10 is assembled with a frame 100. The frame has at least one overhang 101, 102, preferably two overhangs, to hold the printed circuit board 10 together with surface mount reflector 80 within the frame. The at least one overhang 100 preferably interacts with the at least one flat spring 85, 86 to assert a predetermined force to the surface mount reflector. Frame 100 may be designed to act as a mechanical support structure and/or a heat sink and/or electrical insulator for the assembly.

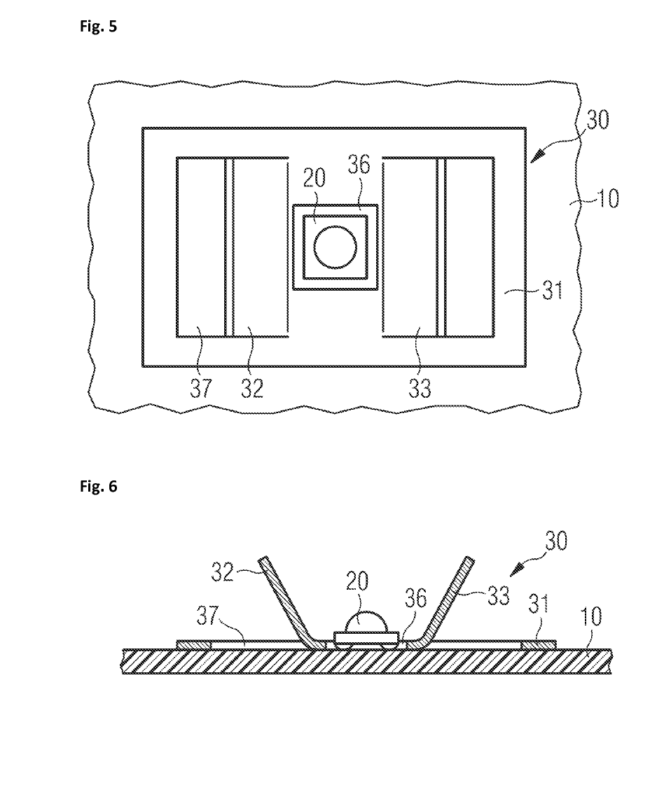

In FIG. 5, a further embodiment according to the invention is shown. At least one LED 20 is mounted to a printed circuit board 10. Furthermore, a surface mount reflector 30 is located on the printed circuit board. This surface mount reflector has at least one blanking or opening 36 for a LED. It further has at least one reflector surface 32. Preferably, there is at least a second reflector surface 33, preferably at the opposite side of the LED in relation to the first reflector 32 surface. Preferably, the reflector surfaces 32, 33 are punched out and bent upwards from the surface mount reflector. This may result in at least one additional blanking 37. There may be further electronic components like LED drivers placed on the printed circuit board within the at least one additional blanking 37.

FIG. 6 shows this embodiment in a side view. Here the surface mount reflector 30 is shown from its side with the reflector surfaces 32, 33 bent upwards in an angle from the reflector base 31, which is located on the printed circuit board 10.

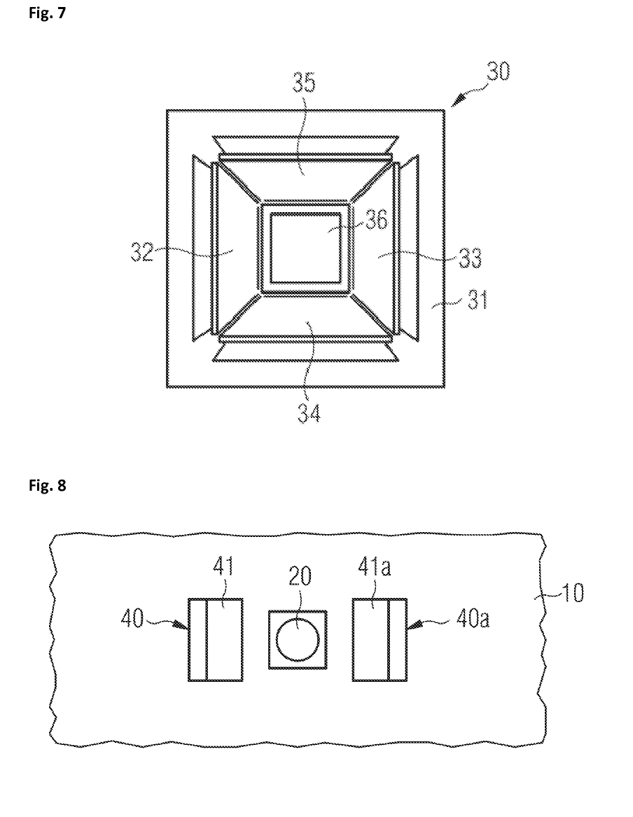

FIG. 7 shows another embodiment, where four reflector surfaces are provided. A first reflector surface 32, second reflector surface 33, third reflector surface 34 and fourth reflector surface 35 enclose the LED, which is placed on a printed circuit board within blanking 36 at four sides.

FIG. 8 shows a basic arrangement of a surface mounted reflector 40 in relationship to a LED 20. The surface mount reflector 40 is a component, which is mounted in close proximity to the LED 20 with its reflecting surface 41 directed towards the LED. There may be further surface mount reflectors 40a with reflecting surfaces 41a arranged in close proximity to the LED 20.

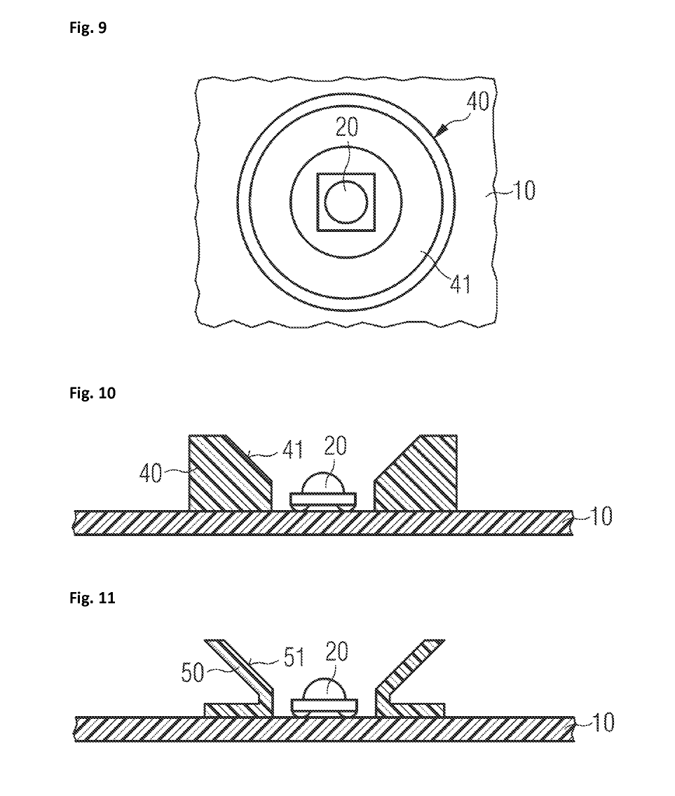

FIG. 9 shows a circular surface mount reflector 40 having a reflecting surface 41 around LED 20.

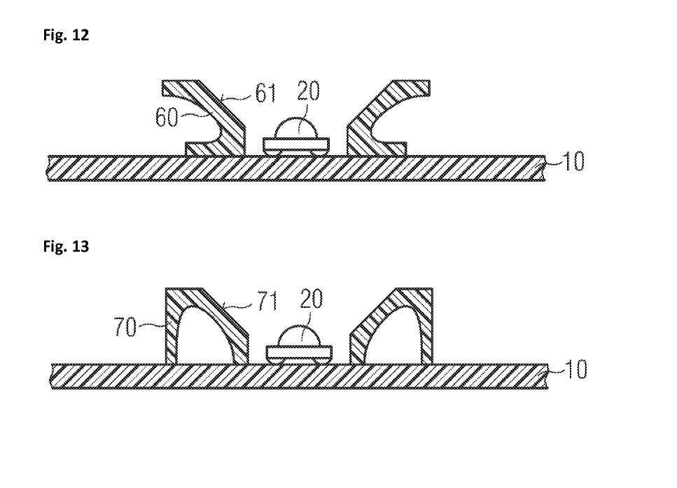

FIGS. 10 to 13 show different embodiments of surface mounted reflectors 40, 50, 60, 70 with their reflecting surfaces 41, 51, 61, 71 directed towards LED 20 mounted on the printed circuit board 10.

It will be appreciated to those skilled in the art having the benefit of this disclosure that this invention is believed to provide LED-based lighting components and a method for manufacturing thereof. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

10 printed circuit board
20 LED
30 surface mount reflector
31 reflector base
32, 33, 34, 35 reflector surfaces
36 blanking for LED
37 blanking
40, 50, 60, 70 surface mount reflectors
41, 51, 61, 71 reflector surfaces
80 surface mount reflector
81 reflector surface
82, 83, 84 mounting pads
85, 86 flat springs
90 surface mount reflector
91 reflector surface
92, 93, 94 mounting pads
95, 96 flat springs
100 frame
101, 102 overhang

1. A light-emitting diode (LED)-based lighting component comprising:
at least one LED mounted to a printed circuit board, and
at least one surface mount reflector located on the printed circuit board, the surface mount reflector having at least one reflector surface oriented towards the at least one LED.

2. The LED-based lighting component of claim 1, wherein the at least one surface mount reflector comprises a metal sheet.

3. The LED-based lighting component of claim 1, wherein the at least one surface mount reflector comprises a ceramic or plastic material that is configured to withstand soldering of the surface mount reflector to the printed circuit board.

4. The LED-based lighting component of claim 1, wherein the at least one surface mount reflector comprises at least one mounting pad soldered to the printed circuit board.

5. The LED-based lighting component of claim 1, wherein the at least one LED is a surface mount device and is soldered to the printed circuit board.

6. The LED-based lighting component of claim 1, wherein the at least one surface mount reflector comprises at least one heat conductive material.

7. LED-based lighting component of claim 1, wherein the at least one surface mount reflector is in thermal communication with the at least one LED and configured to act as a heat sink for the at least one connected LED.

8. The LED-based lighting component of claim 1, wherein a first surface mount reflector and the second surface mount reflector are located on opposing sides of the at least one LED.

9. The LED-based lighting component of claim 1, further comprising:
a frame holding the printed circuit board.

10. LED-based lighting component according to claim 9, wherein the surface mount reflector includes at least one spring interacting with the frame to hold the surface mount reflector down on the printed circuit board.

11. A surface mount reflector configured to be placed on a printed circuit board, comprising:
a surface mount reflector having at least one reflector surface that is configured to reflect light from a LED.

12. The surface mount reflector according to claim 11, wherein the surface mount reflector comprises a metal sheet.

13. The surface mount reflector of claim 11, further comprising:
at least one mounting pad for positioning the surface mount reflector on a printed circuit board.

14. A method for manufacturing a light-emitting diode (LED)-based lighting component of claim 1, the method comprising the steps of:
a) positioning and fixing at least one LED on a printed circuit board, and
b) positioning and fixing a surface mount reflector on a printed circuit board.

15. The method for manufacturing a LED-based lighting component according to claim 14, wherein both steps are performed with the same pick and place machine.

16. The method for manufacturing a LED-based lighting component according to claim 14, wherein the LED and the reflector are soldered to the printed circuit board in the same process step.
